(19) United States
(12) Patent Application Publication
(10) Pub. No.: US 2014/0055085 A1
(43) Pub. Date: Feb. 27, 2014

(54) THIN FILM BATTERY CHARGE CONTROL AND METHOD

(71) Applicant: CYMBET CORPORATION, Elk River, MN (US)

(72) Inventors: Stephen W. Downey, Elk River, MN (US); Nissa Inselman-Field, Otsego, MN (US)

(73) Assignee: CYMBET CORPORATION, Elk River, MN (US)

(21) Appl. No.: 14/003,711

(22) PCT Filed: Feb. 22, 2013
(86) PCT No.: PCT/US2013/027382

§ 371 Date: Sep. 6, 2013

Related U.S. Application Data
(60) Provisional application No. 61/602,161, filed on Feb. 23, 2012.

(51) Int. Cl. H02J 7/00

(52) U.S. Cl. CPC H02J 7/0052
USPC 320/107; 320/137; 320/162

(57) ABSTRACT

A thin film battery and charging system is provided comprising a cathode material, a cathode current collector, an anode current collector, and an electrolyte layer separating the cathode material from the anode current collector configured to form a battery having at least one intercalating electrode. The system additionally comprises an integrated-circuit battery-charging and managing circuit and a user controlled input having selection capability for the user to choose from a plurality of levels of state of charge of the battery. A method of charging a thin film battery is also described.

### CROSS-REFERENCE TO RELATED APPLICATIONS

This application claims the benefit of U.S. Provisional Application Ser. No. 61/602,161, filed Feb. 23, 2012, entitled “THIN FILM BATTERY CHARGE CONTROL AND METHOD” which application is incorporated herein by reference in its entirety.

### FIELD OF THE INVENTION

The present invention relates to chargeable batteries.

### BACKGROUND OF THE INVENTION

Electronics have been incorporated into many portable devices such as computers,

mobile phones, tracking systems, scanners, etc. One drawback to portable devices is the need to include the power supply with the device. Portable devices typically use batteries as power supplies. Batteries must have sufficient capacity to power the device for at least the length of time the device is in use. Sufficient battery capacity can result in a power supply that is quite heavy and/or large compared to the rest of the device. Accordingly, smaller and lighter batteries (i.e., power supplies) with sufficient energy storage are desired. Other energy storage devices, such as supercapacitors, and energy conversion devices, such as photovoltaics and fuel cells, are alternatives to batteries for use as power supplies in portable electronics and non-portable electrical applications.

One type of an energy-storage device is a solid-state, thin-film microbattery. Examples of thin-film batteries are described in U.S. Pat. Nos. 5,314,765; 5,338,625; 5,445,906; 5,512,147; 5,561,004; 5,567,210; 5,569,520; 5,597,660; 5,612,152; 5,654,084; and 5,705,293. U.S. Pat. No. 5,338,625 describes a thin-film battery, especially a thin-film microbattery, and a method for making same having application as a backup or first integrated power source for electronic devices. U.S. Pat. No. 5,445,906 describes a method and system for manufacturing a thin-film battery structure formed with the method that utilizes a plurality of deposition stations at which thin battery component films are built up in sequence upon a web-like substrate as the substrate is automatically moved through the stations.

There continues to be a need for devices and methods that facilitate provision of power supplies in small devices.

### SUMMARY OF THE INVENTION

For rechargeable, Li-ion batteries, the nominal operating voltage is set by the electrochemical potential between metallic lithium (anode or negative electrode) and the cathode material in the positive electrode. For many systems, this is typically 4.1V. When charged to this value, approximately one half of the lithium ions are removed from the cathode. This fraction of mobile ions, coupled with the size of the cathodic material, constitutes the capacity of the battery. During discharge, the Li ions return to the cathode, while a similar number of electrons flow in the external circuit, powering an electronic device. Without any modifications of the system, the capacity of the device can be increased by simply increasing the charging voltage to say, 4.2V. In this case, more Li has been extracted from the cathode, increasing the Li ions available for discharge while reducing the Li remaining in the cathode. Unfortunately, this method of increasing the capacity is not without penalty. The less Li in the cathode, the more susceptible the material becomes to structural deterioration. This problem becomes worse at high temperature, even slightly above room temperature. If cycling occurs with higher-than-nominal charging voltage, the cathode will exhibit faster than usual capacity fade. The impedance of the battery also increases, further decreasing its utility. These unwanted attributes are even more critical if the embodiment is an all solid-state battery in a ‘Li-free’ design, where the anodic lithium originates in the cathode material.

Conversely, if the battery is charged to less than nominal voltage, say 4.05 or 4.0V, or even lower, then more Li remains in the cathode, thus increasing its structural integrity. The user may choose to operate in this fashion, if a smaller amount of capacity is sufficient for use during each cycle. But in the long term, the total amount of energy stored and delivered to a rechargeable application over its lifetime can be increased by prudent, lower voltage operation. This is even more prudent for operation at high temperature.

Conventional thin film battery and charging systems as provided with circuitry that establishes the level of the state of charge of the battery. This means that the battery manufacturer makes a design decision that determines whether the battery will be charged to a relatively high voltage, thereby maximizing initial capacity, or instead designing the battery to be charged to a relatively lower voltage, thereby increasing the lifetime of the battery.

A thin film battery and charging system is provided comprising a cathode material, a cathode current collector, an anode current collector, and an electrolyte layer separating the cathode material from the anode current collector configured to form a battery having at least one intercalating electrode. The system additionally comprises an integrated-circuit battery-charging and managing circuit and a user controlled input having selection capability for the user to choose from a plurality of levels of state of charge of the battery.

A method of charging a battery is also provided comprising

a) providing a thin film battery and charging system comprising:
a cathode material, a cathode current collector, an anode current collector, and an electrolyte layer separating the cathode material from the anode current collector configured to form a battery having at least one intercalating electrode;
an integrated-circuit battery-charging and managing circuit;
a user controlled input having selection capability for the user to choose from a plurality of levels of state of charge of the battery;

b) determining the level of state of charge desired for the battery based on an intended application of the battery; and

c) selecting the level of state of charge of the battery by operation of the user controlled input based on the determination of step b).

The present thin film battery and charging system uniquely provides flexibility in a single manufactured system to allow the manufacturer or a later purchaser to determine whether the battery is to be charged for greater initial capacity or for longer life. This provides substantial savings in manufacturing and inventory cost because it removes the necessity to stock two different types of batteries to meet the two different functional needs. Additionally, the present system provides an intermediate consumer who is a manufacturer of electronic components incorporating a thin film battery maximum product flexibility and ability to adapt the battery to changing product requirements.

### DESCRIPTION OF PRESENTLY PREFERRED EMBODIMENTS

The embodiments of the present invention described below are not intended to be exhaustive or to limit the invention to the precise forms disclosed in the following detailed description. Rather, a purpose of the embodiments chosen and described is so that the appreciation and understanding by others skilled in the art of the principles and practices of the present invention can be facilitated.

As noted above, the thin film battery and charging system comprises a user controlled input having selection capability for the user to choose from a plurality of levels of state of charge of the battery. In an embodiment of the present invention, the user controlled input permits selection of maximum and minimum values of state of charge of the battery. In an embodiment of the present invention, the user controlled input permits selection of state of charge at either at a first setting of a number or range of state of charge greater than 95% or at a second setting of a number or range of a state of charge of from 30% to 90%. In an embodiment of the present invention, the user controlled input permits selection of state of charge to define a minimum number of predicted charge cycles, which defined minimum number is greater than the predicted charge cycles of a battery having a state of charge greater than 95%. In an embodiment of the present invention, the state of charge is controlled in at least one of the state of charge levels by limiting the charge potential to less than 4.05V. In an embodiment of the present invention, the state of charge is controlled in at least one of the state of charge levels by limiting discharge potential to more than 2.0V.

The thin film battery and charging system additionally comprises an integrated-circuit battery-charging and managing circuit In an embodiment of the present invention, the integrated-circuit battery-charging and managing circuit comprises a control feature to limit the state of charge when the battery exceeds a temperature of 40° C.

The thin film battery and charging system additionally comprises a battery having at least one intercalating electrode. In an embodiment of the present invention, the battery is a solid state battery. In an embodiment of the present invention, the battery forms a lithium metal anode during initial charge.

While not being bound by theory, it is believed that controlling the level of charge of the battery to less than full state of charge results in less damage to the cathode material during charge cycles. This permits the battery to achieve high cycle efficiency and reduces cycle fade.

In an embodiment of the present invention, batteries are controlled to provide a state of charge that is less than 90% and that provides a thin film battery delivering the desired capacity per cycle (e.g. 50 μAh) for greater than 300 cycles, 3000 cycles or 5000 cycles. Preferably, the control of charge as described herein provides a statistically significant increase of reliability of the battery of ordinary cycle life expectancy as compared to a like battery charged to greater than 90% state of charge. In an embodiment, the battery increases the number of reliable cycles by greater than 25% as compared to a like battery charged to greater than 90% state of charge.

The present invention is particularly useful for providing batteries that can be adapted by selection of the level of state of charge to survive challenging environmental conditions. In an aspect of the present invention, superior performance of batteries in particular can be achieved by batteries that are exposed to prolonged elevated temperature, such as greater than or equal to about 70° C. or greater than or equal to about 85° C. In another aspect of the present invention, superior performance of batteries in particular can be achieved by batteries that are exposed to temperature cycles, such as one or more cycles from room temperature (e.g. about 22° C.) to elevated temperature, for example greater than or equal to about 40° C. or greater than or equal to about 70° C. or greater than or equal to about 85° C.

In addition to user selection of the charging voltage, the user may also be provided with control of the final discharge voltage, as this parameter also influences the amount of Li retained in the cathode during operation. As a rule-of-thumb, both the charging and discharge voltage should be adjusted to provide the required amount of needed energy on each cycle, while keeping the cathode as full of Li as possible. This typically means keeping both the charging and discharging voltage low, especially at above room temperature operation. In an embodiment of the invention, the battery system is provided with a discharge minimum, so that the battery will be discharged to a discharge voltage that is no less than about 30%, or in another embodiment no less than about 45% of the rated capacity of the cell at a given temperature. In embodiments of the present invention, the given temperature for evaluating the charge and discharge is at a temperature selected from 22° C., 40° C., 70° C. and 85° C.

In an embodiment of the present invention, one of the selections for levels of state of charge is to have a maximum state of charge of no greater than 90% and a minimum state of charge of no less than 30%.

In another embodiment of the present invention, one of the selections for levels of state of charge is to have a maximum state of charge of no greater than 85% and a minimum state of charge of no less than 30%. In another embodiment of the present invention, one of the selections for levels of state of charge is to have a maximum state of charge of no greater than 80% and a minimum state of charge of no less than 30%.

In another embodiment of the present invention, one of the selections for levels of state of charge is to have a maximum state of charge of no greater than 90% and a minimum state of charge of no less than 35%. In another embodiment of the present invention, one of the selections for levels of state of charge is to have a maximum state of charge of no greater than 90% and a minimum state of charge of no less than 40%. In another embodiment of the present invention, one of the selections for levels of state of charge is to have a maximum state of charge of no greater than 90% and a minimum state of charge of no less than 45%. In another embodiment of the present invention, one of the selections for levels of state of charge is to have a maximum state of charge of no greater than 85% and a minimum state of charge of no less than 40%.

Each of the above selections of state of charge may be evaluated at a temperature selected from 22° C., 40° C., 70° C. and 85° C.

A method of charging a battery is also provided comprising

a) providing a thin film battery and charging system comprising:

a cathode material, a cathode current collector, an anode current collector, and an electrolyte layer separating the cathode material from the anode current collector configured to form a battery having at least one intercalating electrode;

an integrated-circuit battery-charging and managing circuit;

a user controlled input having selection capability for the user to choose from a plurality of levels of state of charge of the battery;

b) determining the level of state of charge desired for the battery based on an intended application of the battery; and
c) selecting the level of state of charge of the battery by operation of the user controlled input based on the determination of step b).

In an embodiment, the method further comprises charging the battery to the desired state of charge. In an embodiment, the method further comprises disabling the charge operation once the desired state of charge is achieved. In an embodiment, the method further comprises exposing the battery to a temperature greater than 40° C.

For example, a battery may be provided with a user controlled input having selection capability for the user to choose from a plurality of levels of state of charge of the battery. If the battery has a rated capacity per cycle of 4.1V at 70° C., one of the selections can be that the battery is charged to a voltage potential of about 3.95V instead of the nominal 4.1V. The system may additionally be provided with a minimum discharge voltage control, so that the above referenced battery is permitted to discharge no lower than 2.5V in one embodiment, or no lower than 2.0V in another embodiment.

Aspects of the thin film batter itself will now be discussed.

The rechargeable thin film microbattery cells used in the present system may be configured in a variety of ways and manufactured using various materials as will now be appreciated by the skilled artisan. In an embodiment, the microbattery cell is provided in a fully charged state, or in a “pre-charged” state. An example of a microbattery cell in a pre-charged state is an assembly of microbattery cell components that does not contain a functional amount of metallic lithium anode, but which, when sufficiently charged, contains a functional metallic lithium anode. Thus, thin film microbatteries of the present invention may be an assembly of components that has never been charged, or that has been partially charged, but not sufficiently charged to contain metallic lithium in an amount sufficient to function as a practical microbattery (i.e. sufficient to power a component such as an ASIC for its intended operational cycle).

Thin film microbattery cells when fully charged comprise a cathode current collector, a cathode, an electrolyte, and anode and an anode current collector. The microbattery cell typically is manufactured on a substrate. In a preferred embodiment of the present invention, the thin film microbattery cell is initially constructed without an anode, but with a cathode layer that can act as a source of lithium ions. Upon charging of this thin film microbattery cell embodiment, metallic lithium is plated between the electrolyte and the anode current collector to form an anode. Alternatively, the anode may be formed by intercalation of the anode material in a layer receptive for forming and anode layer. For example, the cathode layer may be a material such as LiCoO₂ that can act as a source of lithium ions. Likewise, the thin film microbattery cell may be initially constructed without a cathode layer that is subsequently formed during charging. Examples of thin-film batteries are described in U.S. Pat. Nos. 5,314,765; 5,338,625; 5,445,906; 5,512,147; 5,561,004; 5,567,210; 5,569,520; 5,597,660; 5,612,152; 5,654,084; 5,705,293; 6,906,436; 6,986,965; 7,931,989; 7,776,478; and 7,939,205 and US Publication Nos. 2009/0214899 and 2007/0012244 each of which is herein incorporated by reference for all purposes, particularly with respect to the construction methodologies and materials selection of the microbattery cell components and embodiments of devices comprising thin film batteries.

All percentages and ratios used herein are weight percentages and ratios unless otherwise indicated. All patents, patent applications (including provisional applications), and publications cited herein are incorporated by reference as if individually incorporated for all purposes. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

1. A thin film battery and charging system comprising:
a cathode material, a cathode current collector, an anode current collector, and an electrolyte layer separating the cathode material from the anode current collector configured to form a battery having at least one intercalating electrode;
an integrated-circuit battery-charging and managing circuit;
a user controlled input having selection capability for the user to choose from a plurality of levels of state of charge of the battery.

2. The thin film battery and charging system of claim 1, wherein the user controlled input permits selection of maximum and minimum values of state of charge of the battery.

3. The thin film battery and charging system of claim 1, wherein the user controlled input permits selection of state of charge at either at a first setting of a number or range of state of charge greater than 95% or at a second setting of a number or range of a state of charge of from 30% to 90%.

4. The thin film battery and charging system of claim 1, wherein the user controlled input permits selection of state of charge to define a minimum number of predicted charge cycles, which defined minimum number is greater than the predicted charge cycles of a battery having a state of charge greater than 95%.

5. The thin film battery and charging system of claim 1, wherein the integrated-circuit battery-charging and managing circuit comprises a control feature to limit the state of charge when the battery exceeds a temperature of 40° C.

6. The thin film battery and charging system of claim 1, wherein the battery is a solid state battery.

7. The thin film battery and charging system of claim 1, wherein the battery forms a lithium metal anode during initial charge.

8. The thin film battery and charging system of claim 7, wherein the state of charge is controlled in at least one of the state of charge levels by limiting the charge potential to less than 4.05V.

9. The thin film battery and charging system of claim 7, wherein the state of charge is controlled in at least one of the state of charge levels by limiting discharge potential to more than 2.0V.

10. A method of charging a battery comprising
a) providing a thin film battery and charging system comprising:
a cathode material, a cathode current collector, an anode current collector, and an electrolyte layer separating the cathode material from the anode current collector configured to form a battery having at least one intercalating electrode;
an integrated-circuit battery-charging and managing circuit;
a user controlled input having selection capability for the user to choose from a plurality of levels of state of charge of the battery;
b) determining the level of state of charge desired for the battery based on an intended application of the battery; and
c) selecting the level of state of charge of the battery by operation of the user controlled input based on the determination of step b).

11. The method of claim 10, further comprising charging the battery to the desired state of charge.

12. The method of claim 11, further comprising disabling the charge operation once the desired state of charge is achieved.

13. The method of claim 12, further comprising exposing the battery to a temperature greater than 40° C.
